(19) United States
(12) Patent Application Publication
(10) Pub. No.: US 2012/0075587 A1
(43) Pub. Date: Mar. 29, 2012

(54) VIDEO PROJECTOR

(75) Inventors: Yusuke YAMAMOTO, Osaka-shi (JP); Toshihiro Saruwatari, Kishiwada-shi (JP); Chao Wang, Shenzhen (CN)

(73) Assignees: Sanyo Technology Center (Shenzhen) Co., Ltd., Shenzhen (CN); Sanyo Electric Co., Ltd., Osaka (JP)

(21) Appl. No.: 13/243,140

(22) Filed: Sep. 23, 2011

(30) Foreign Application Priority Data
Sep. 29, 2010 (JP) 2010-219836

(51) Int. Cl. G03B 21/16

(52) U.S. Cl. 352/146

(57) ABSTRACT

A projector is provided with a lamp including an arc tube, which generates light, and a reflector. The reflector includes an inner surface that reflects light from the arc tube and an opposite outer surface. The arc tube and the inner surface define an inner portion of the lamp. At least the outer surface defines an outer portion of the lamp. A housing accommodates the lamp and includes an air inlet through which air is drawn in from outside the housing. An air mixing structure mixes a cooling current that has cooled the inner portion of the lamp with the air drawn into the housing through the air inlet. A cooling current guide structure guides the cooling current mixed with the air mixing structure to the outer portion of the lamp.

### CROSS-REFERENCE TO RELATED APPLICATIONS

This application is based upon and claims the benefit of priority from prior Japanese Patent Application No. 2010-219836, filed on Sep. 29, 2010, the entire contents of which are incorporated herein by reference.

### BACKGROUND OF THE INVENTION

The present invention relates to a video projector provided with a lamp that includes an arc cube and a reflector.

A typical video projector includes a lamp that functions as a light source used to display an image. The lamp includes an arc tube, which generates light when an electric discharge occurs, and a reflector, which reflects the light from the arc tube in a predetermined direction.

Generally, a lamp, which is heated when generating light, is air-cooled. For example, in such a lamp, ambient air is drawn into a housing of the projector. The drawn-in air forms a cooling current guided to an inner portion and outer portion of the lamp, which serves as a cooling subject (refer to Japanese Laid-Open Patent Publication No. 2010-26522).

The inner portion of the lamp includes the are tube and the inner surface of the reflector. In comparison with the outer portion of the lamp, the temperature becomes relatively high at the inner portion of the lamp due to the light generated by the lamp (i.e., arc tube). It is thus important that. the inner portion of the lamp be cooled.

In the lamp described in Japanese Laid-Open Patent Publication No. 2010-26522, the cooling current guided to the lamp is separated into a flow that cools the inner portion of the lamp and a flow that cools the outer portion of the lamp. This reduces the amount of air in the cooling current that cools the inner portion of the lamp.

To effectively cool the lamp, the outer portion of the lamp should be effectively cooled. However, unless the temperature of the cooling current is low, the outer portion of the lamp cannot be effectively cooled.

The present invention provides a video projector that cools the inner and outer portions of a lamp with the same flow of a cooling current and effectively cools the outer portion of the lamp.

One aspect of the present invention is a video projector provided with a lamp including an arc tube, which generates light, and a reflector, which includes an inner surface that reflects light from the arc tube and an opposite outer surface. The are tube and the inner surface define an inner portion of the lamp, and at least the outer surface defines an outer portion of the lamp. A housing accommodates the lamp and includes an air inlet through which air is drawn into the housing from outside the housing. An air mixing structure mixes a cooling current that has cooled the inner portion of the lamp with the air drawn into the housing through the air inlet. A cooling current guide structure guides the cooling current mixed with the air mixing structure to the outer portion of the lamp.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIGS. 1(a) and 1(b) are perspective views showing a video projector according to one embodiment of the present invention;

FIG. 2 is a schematic diagram showing an optical system of the projector;

FIG. 3 is a perspective view showing a lamp unit of the projector;

FIGS. 4(a) and 4(b) are side views showing the lamp unit;

FIG. 5 is a perspective view showing a state in which the lamp unit is arranged in a lamp base;

FIG. 6 is a plan view showing a state in which the lamp unit is arranged in the lamp base;

FIG. 7 is a perspective view showing a state in which the lamp unit is removed from the lamp base;

FIG. 8 is a schematic cross-sectional view showing the flow of a cooling air current in the projector; and

FIG. 9 is a perspective view showing, in cross-section, the flow of a cooling air current in the projector.

### DETAILED DESCRIPTION OF THE INVENTION

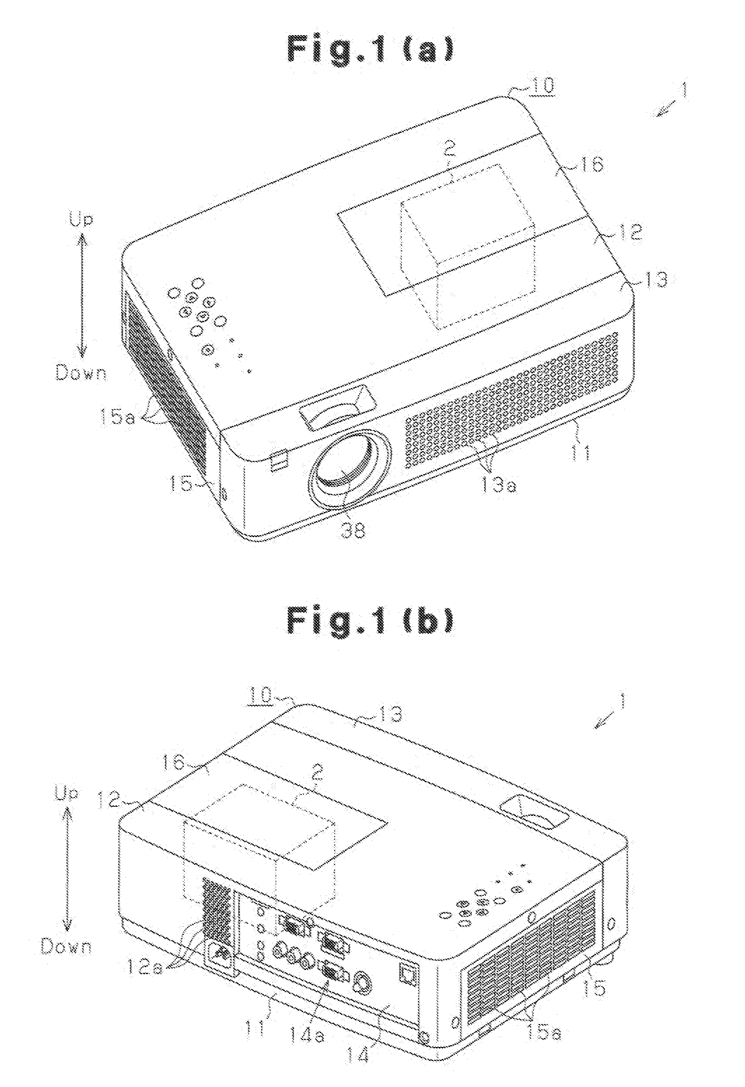

A video projector 1 according to one embodiment of the present invention will now be described. In the description hereafter, the state of the projector 1 as shown in FIGS. 1(a) and 1(b) will be used as the frame of reference for the upward and downward directions.

Referring to FIGS. 1(a) and 1(b), the projector 1 projects and displays an image on a projection surface such as a screen or a wall. The projector 1 includes a housing 10, which accommodates electronic and optical components.

The housing 10 includes a lower case 11, an upper case 12 covering the upper side of the lower case 11, a front panel 13, a rear panel 14 (refer to FIG. 1(b))), a filter cover 15, and a lamp cover 16 covering a lamp 2. A projection lens 38 is arranged in the front panel 13. The rear panel 14 and front panel 13 are arranged on opposite sides of the housing 10. Various types of connection terminals are arranged in a terminal unit 14a on the rear panel 14.

Referring to FIG. 1(b), a plurality of air inlets 12a are arranged in the upper case 12 near the lamp 2 to draw ambient air into the housing 10. In the same manner, a plurality of air inlets 13a and 15a are arranged in the front panel 13 and the filter cover 15 to draw ambient air into the housing 10.

As described above, the air inlets 12a, 13a, and 15a are formed in the housing 10 to draw ambient air into the housing 10. Accordingly, the projector 1 draws ambient air under normal temperatures into the housing 10 through the air inlets 12a, 13a, and 15a to cool a cooling subject in the projector 1 with the drawn-in air.

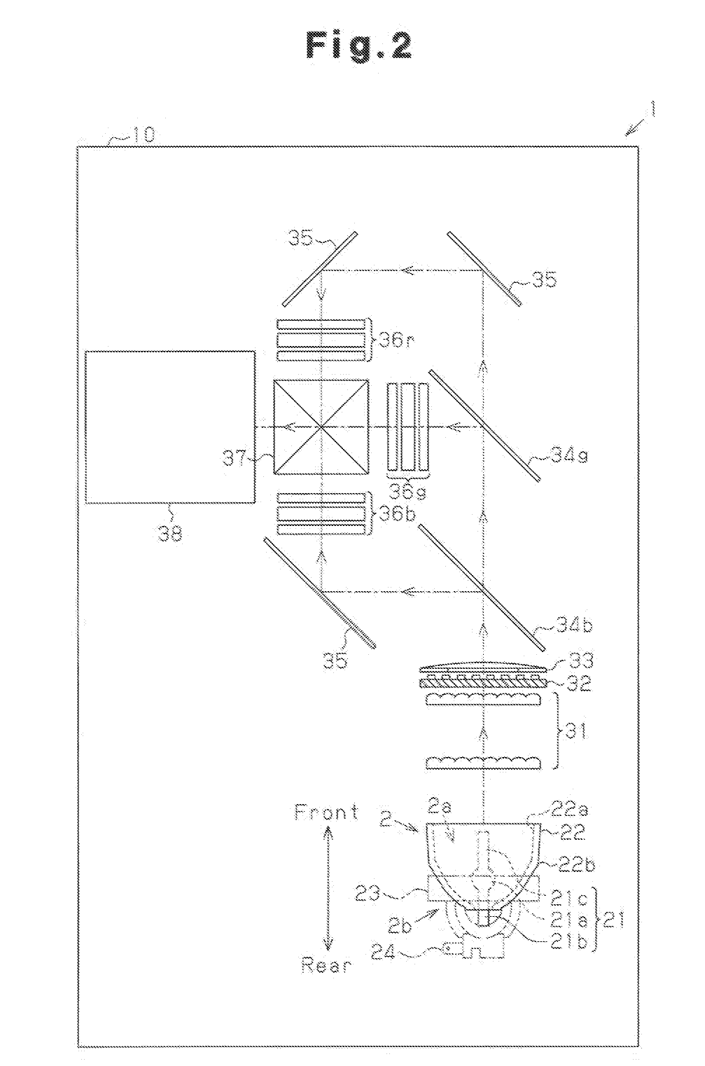

Referring to FIG. 2, the optical components of the projector 1 arranged in the housing 10 include the lamp 2, dichroic mirrors 34b and 34g, and liquid crystal light valves 36r, 36g, and 36b. The lamp 2 serves as a light source used to display an image. The dichroic mirrors 34 and 34g separate white light into the three primary colors of light, which are red, green, and blue. The liquid crystal light valves 36r, 36g, and 36b respectively correspond to the red light, green light, and blue light.

The lamp 2 may be a discharge lamp, such as an ultrahigh pressure mercury lamp or a metal halide lamp. The lamp 2 includes an arc tube 21, a reflector 22, a terminal support 23, and a connection terminal 24. The arc tube 21 generates light when an electric discharge occurs. The reflector 22 reflects the light from the arc tube 21 in a predetermined direction. The terminal support 23 is arranged at the outer side of the reflector 22. The connection terminal 24 is supported by the terminal support 23.

The arc tube 21 includes a spherical luminous body 21a and cylindrical electrode containers 21b and 21c. A mixture of mercury and halogen gas or a halogen compound is sealed in the luminous body 21a. The electrode containers 21b and 21c are coupled to opposite sides of the luminous body 21a and confine parts of an electrode (not shown), which extends into the luminous body 21a. The electrode container 21b, which forms one end of arc tube 21, is inserted through the reflector 22. The electrode container 21c, which forms the outer end of the arc tube 21 is a arranged together with the luminous body 21a facing toward an inner surface 22a of the reflector 22. The lame 2 emits white light when the arc tube 21 glows. Further, the lamp 2 emits light toward the front.

The reflector 22 is a reflection mirror including the inner surface 22a, which reflects the light of the arc tube 21, and an opposite outer surface 22b. Since the inner surface 22a of the reflector 22 reflects the light of the are tube 21, more light is sent to the liquid crystal light valves 36r, 36g, and 36b in comparison to when the reflector 22 is not used.

The terminal support 23 is arranged at the rear end of the reflector 22. The connection terminal 24, which is supported by the terminal support 23, is electrically connected to the electrode (not shown) arranged in th arc tube 21. Through the connection terminal 24, the lamp 2 is supplied with power that produces an electrical discharge.

As described above, the lamp 2 includes an inner portion 2a and an outer portion 2b. In the present embodiment, the inner portion 2a includes the inner surface 22a of the reflector 22 and the arc tube 21. The outer portion 2b includes the outer surface 22b of the reflector 22 and the terminal support 23, which is arranged outside the reflector 22.

The light emitted from the lamp 2 is guided by the dichroic mirrors 34b and 34g and the mirror 35 to the liquid crystal light valves 36r, 36g, and 36b. Here, an integrator lens 31, which is formed by two fly's eye lenses, functions to obtain a uniform illuminance distribution. A polarizer 32 sets the uniform light in a predetermined polarization direction. A condenser lens 33 converges light and provides the converged light to the liquid crystal light valves 36r, 36g, and 36b.

The dichroic mirror 34b reflects light having a wavelength corresponding to blue, and the dichroic mirror 34g reflects light having a wavelength corresponding to green. The white light from the lamp 2 is separated by the dichroic mirrors 34b and 34g into light having a wavelength corresponding to red (hereinafter referred to as red light), light having a wavelength corresponding to green (hereinafter referred to as green light), and light having a wavelength corresponding to blue (hereinafter referred to as blue light).

Red light, which is separated from the white light, enters the liquid crystal light valve 36r. Green light, which is separated from the white light, enters the liquid crystal light valve 36g. Blue light, which is separated from the white light, enters the liquid crystal light valve 36b. Each of the liquid crystal light valves 36r, 36g, and 36b varies the transmittance of light for each of the pixels forming a single image. Further, each of the liquid crystal light valves 36r, 36g, and 36b includes a liquid crystal panel, an entrance side optical component arranged at the side in which light enters the liquid crystal panel, and an exit side optical component arranged at the side in which light exits the liquid crystal panel. The liquid crystal panel also includes at least transparent substrates sandwiching liquid crystal molecules. The entrance side optical component and exit side optical component each include at least a polarization plate.

Red light passes through the liquid crystal light valve 36r. This generates a red image. Green light passes through the liquid crystal light valve 36g. This generates a green image. Blue light passes through the liquid crystal light valve 36b. This generates a blue image.

The optical components further include a cross dichroic prism 37 and the projection lens 38. The cross dichroic prism 37 combines the light of the images of the three primary colors. The projection lens 38 includes a group of lenses that projects the light of an image.

The cross dichroic prism 37 combines the light of the red, green, and blue images generated by the liquid crystal light valves 36r, 36g, and 36b to generate at full-color image of three or more colors. The light of the full-color image is provided to the projection lens 38 from the cross dichroic prism 37.

The projection lens 38 projects light of tie full-color image toward a flat surface, such as a screen or a wall. In this manner, the projector 1 displays an image on a flat surface. As apparent from the above description, the illustrated projector 1 is a three-chip LCD projector.

In the present embodiment, the lamp 2 may be exchanged. For example, when the life of the lamp 2 comes to an end, the lamp 2 can be replaced with a new one by opening the lamp cover 16.

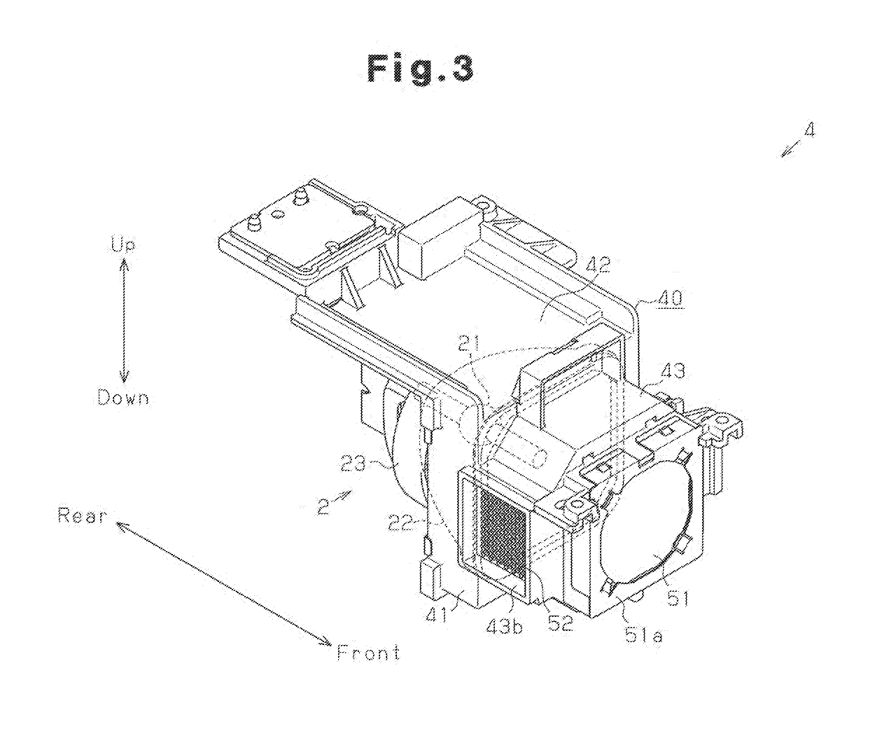

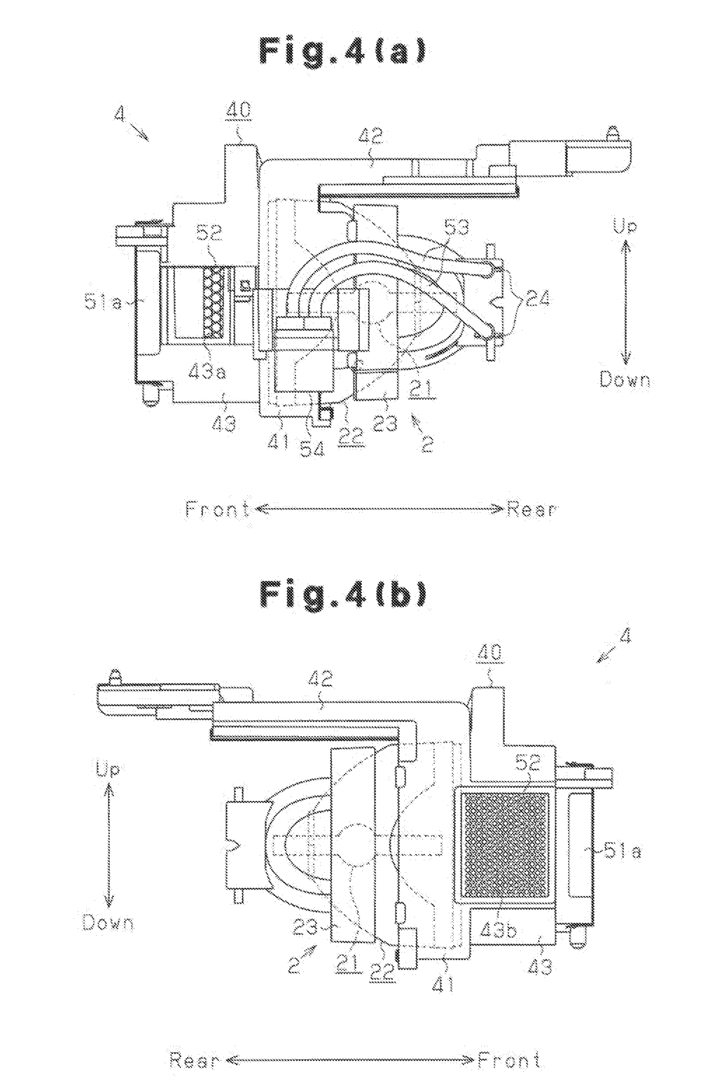

Referring to FIGS. 3 and 4, in the present embodiment, a lamp unit 4, which includes the lamp 2, is arranged in the housing 10. Accordingly, the lamp unit 4 can be replaced to replace the lamp 2. The structure of the lamp unit 4 will now be described with reference to FIGS. 3, 4 (a), and 4(b).

The lamp unit 4 includes the lamp 2 and a lamp holder 40, which supports the lamp 2. The lamp holder 40 includes a support bracket 41, an upper plate 42, and a conduit 43. The support bracket 41 supports the reflector 22 of the lamp 2. The upper plate 42 covers the upper side of the lamp 2. The conduit 43 coves the inner portion 2a of the lamp 2 and circulates the cooling current.

The front end of the reflector 22 is fixed to the support bracket 41. The upper plate 42, which extends toward the rear from the support bracket 41, is coupled to the upper end of the support bracket 41. The hollow conduit 43, which extends toward the front from the support bracket 41, is coupled to the front end of the support bracket 41.

The conduit 43 forms a space between the inner portion 2a of the lamp 2 and a transparent cover 51, which is coupled to the lamp holder 40. As shown in FIG. 4(a), the conduit 43 includes an intake port 43a. A current of cooling air is drawn into the intake port 43a to cool the inner portion 2a of the lamp 2. As shown in FIGS. 3 and 4(b), the conduit 43 further includes a discharge port 43b. The cooling current that has cooled the inner portion 2a of the lamp 2 is discharged from the lamp unit 4 through the discharge port 43b.

The lamp unit 4 includes the transparent cover 51, a lattice 52 arranged in each of the intake port 43a and discharge port 43b, lamp wires 53, and a power receiving connector 54. The transparent cover 51 is coupled to the lamp holder 40. The lamp wires 53 are connected to the lamp 2 and the power receiving connector 54.

The transparent cover 51 is formed by, for example, a transparent glass cover. Further, the transparent cover 51 is held and fixed between the front end of the conduit 43 and a fastener 51a, which is fitted to the transparent cover 51 and the conduit 43. In case the arc tube 21 breaks when the life of the lamp 2 ends, the transparent cover 51, which is arranged in front of the lamp 2, prevents broken fragments of the arc tube 21 from scattering. In the present embodiment, the inner surface 22a of the reflector 22 is ellipsoidal, and the transparent cover 51 functions to collimate the light emitted from the lamp 2.

Each lattice 52 is formed by a metal plate including a plurality of holes. The lattice 52 arranged in the intake port 43a allows cooling current to be drawn into the lamp unit 4, while also preventing broken fragments of the arc tube 21 from being scattered. In the same manner, the lattice 52 arranged in the discharge port 43b allows cooling air to be discharged from the lamp unit 4, while also preventing broken fragments of the are tube 21 from being scattered.

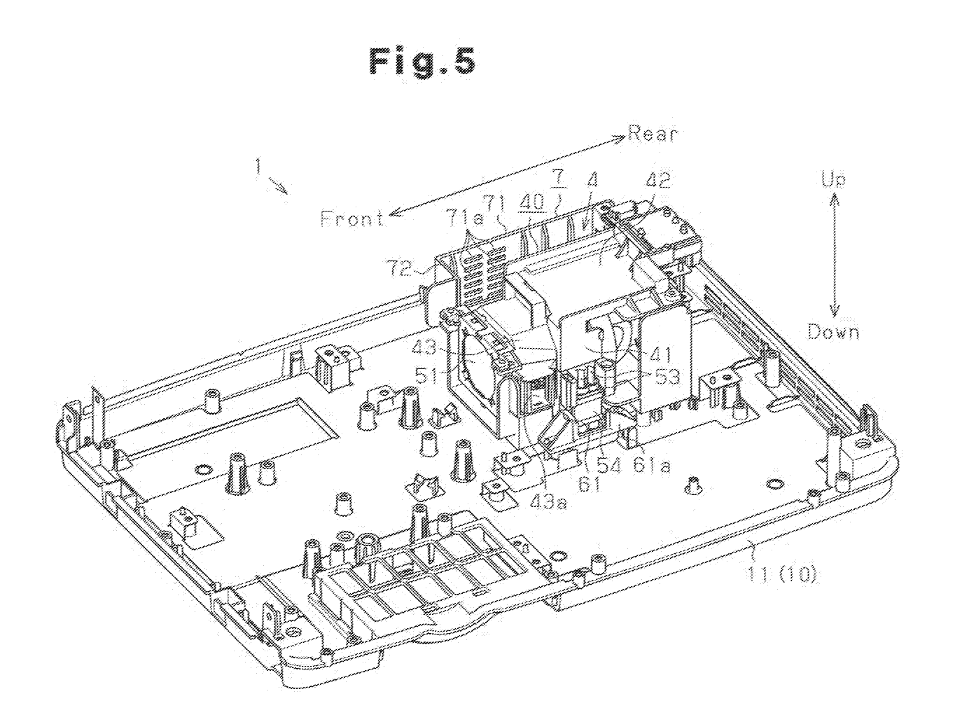

As shown in FIG. 4(a), the power receiving connector 54, which is connected to the lamp wires 53, is arranged on the support bracket 41. The power receiving connector 54 is fastened by screws to the lamp unit 4. A power feeding connector 61 (refer to FIG. 5) is connected in a removable manner to the power receiving connector 54 to supply the lamp 2 with power from a power supply unit (not shown arranged in the housing 10.

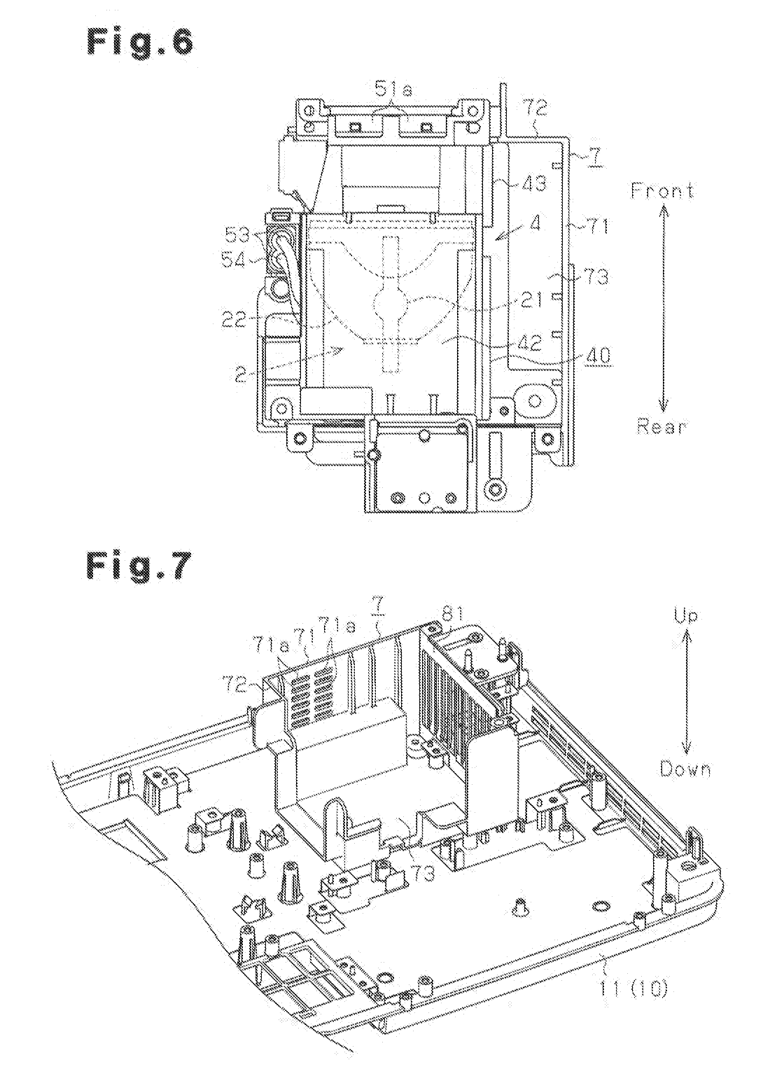

FIG. 5 is a perspective view showing a state in which the lamp unit 4 is fixed to the housing 10. FIG. 6 is a plan view showing a state in which the lamp unit 4 is arranged in a lamp base 7, which is arranged in the housing 10. FIGS. 5 and 6 show the lamp 2. However, FIGS. 5 and 6 does not show other optical components, the power supply unit, which is arranged in the housing 10, and the wiring connecting the power supply unit and the power feeding connector 61. Further, FIG. 5 shows the lower case 11 of the housing 10 but FIG. 6 does not show the lower case 11.

As shown in FIG. 5, the projector 1 includes the lamp base 7, which is arranged in the housing 10. The lamp base 7 accommodates the lamp unit 4 and surrounds at least part of the lamp 2. In the present embodiment, the lamp unit 4, which includes the lamp 2, is surrounded by the walls of the lamp base 7 except at the front, rear, and upper sides.

The lamp base 7 is discrete from the housing 10. The lamp base 7 is coupled to the housing 10 in a removable manner. In the present embodiment, the lamp base 7 is coupled to the lower case 11 of the housing 10.

In a state in which the power receiving connector 54 of the lamp unit 4 is connected to the power feeding connector 61 (refer to FIG. 5), the lamp unit 4 is received in and fixed to the lamp base 7. A connector holder 6 a holds and fixes the power feeding connector 61 to the lower case 11 of the housing 10.

In a state in which the lamp unit 4 is received in the lamp base 7 the lamp unit 4 is lifted for removal from the lamp base 7. FIG. 7 is a perspective view showing a state in which the lamp unit 4 is removed from the lamp base 7. FIG. 7 shows a state in which the power feeding connector 61, the connector holder 61a, the optical components including the lamp 2, the power supply unit, and the wiring connecting the power supply unit and power feeding connector 61 are removed from the housing 10.

As shown in FIGS. 6 and 7, the lamp base 7 includes a side wall 71, a front wall 72, and a lower wall 73. The side wall 71 extends between the front and rear of the lamp base 7. The front wall 72 connects to the front end of the side wall 71. The lower wall 73 connects to the lower end of the side wall 71.

When the lamp unit 4 is received in the lamp base 7, the side wall 71, which extends in the vertical direction, is spaced apart from the conduit 43, which includes the discharge port 43b. The front of the gap formed between the lamp unit 4 and the side wall 71 is closed by the front wall 72, which is arranged at the front end of the lamp base 7.

As shown in FIG. 7, a plurality of circulation holes 71a extends through the side wall 71 of the lamp base 7. The circulation holes 71a are elongated in a frontward direction.

A lamp shield 81 (refer to FIG. 7) is arranged at the rear end of the lamp base 7. The lamp shield 81 closes the lamp base 7 including the space formed between the lamp unit 4 and the side wall 71. The lamp shield 81 includes a plurality of gaps extending in the vertical direction. Thus, the lamp shield 81 allows air to flow out of the lamp base 7, while shielding the lamp unit 4 to prevent light emission and magnetic field leakage from the rear of the lamp unit 4.

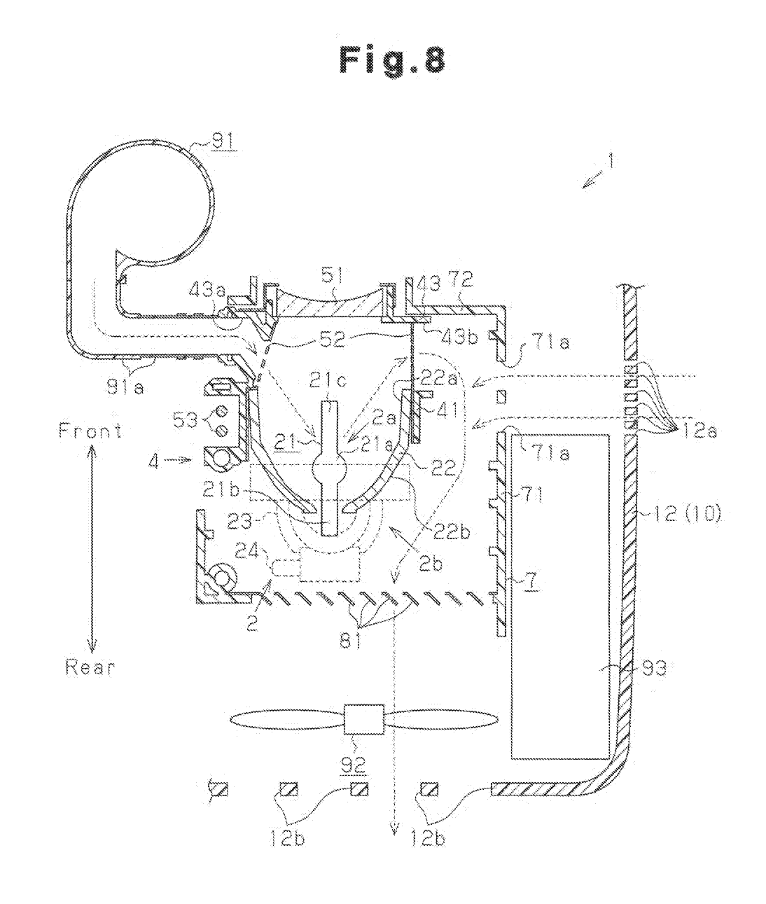

As shown in FIG. 8, the projector 1 further includes a fan 91, which sends a cooling current to the lamp 2, and a discharge fan 92, which discharges air out of the housing 10. FIG. 8 is a schematic cross-sectional view of the projector 1 and shows the flow of cooling currents produced by the fan 91 and the discharge fan 92 with the arrows of the broken lines. FIG. 8 does not show rotor blades of the fan 91.

The fan 91 is, for example, a sirocco fan that forces the air drawn into the housing 10 in a centrifugal direction. A duct 91a is coupled to the fan 91. The cooling current produced by the fan 91 is sent through the duct 91a to the intake port 43a of the lamp unit 4.

The discharge fan 92, which is formed by, for example, an axial fan, sends the air in the lame base 7 out of the housing 10 through the gaps formed in the lamp shield 81 and air outlets 12b. The discharge fan 92, which is arranged outside the lamp base 7, is aligned with the lamp shield 81 and the air outlets 12b, which are formed in the upper case 12 of the housing 10. Accordingly, when the lamp unit 4 is received in the lamp base 7, the discharge fan 92 is arranged rearward from the outer portion of the lamp 2 facing toward the lamp 2.

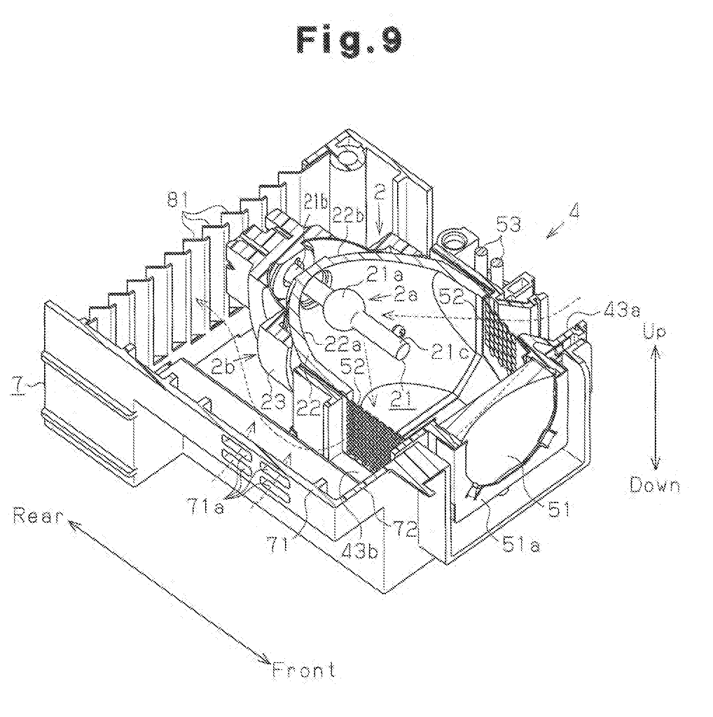

The projector 1 includes an air mixing structure, which mixes the cooling current that has cooled the inner portion 2a of the lamp 2 with the air drawn into the housing through the air inlets 12a, and a cooling current guide structure, which guides the cooling current mixed with the air by the air mixing structure to the outer portion 2b of the lamp 2. The flow of the cooling current that cools the lamp 2 will now be described together with the air mixing structure and the cooling current guide structure with reference to FIGS. 8 and 9.

FIG. 9 is a cross-sectional view of the lamp unit 4 and the lamp base 7 and shows the flow of the cooling current with the arrows of the broken lines in the same manner as FIG. 8.

Referring to FIGS. 8 and 9, the cooling current produced by the fan 91 (refer to FIG. 8) is drawn into the lamp unit 4 through the intake port 43a. The space formed by the inner surface 22a of the reflector 22 defines an internal portion of the lamp unit 4. Thus, the cooling current from the fan 91 enters the internal portion of the lamp unit 4 and cools the inner portion 2a of the lamp 2.

The cooling current that has cooled the inner portion 2a of the lamp 2 is discharged out of the lamp unit 4 through the discharge port 43b. In the present embodiment, the cooling current that has cooled the inner portion 2a of the lamp 2 strikes the side wall 71, which serves as the cooling current guide structure and extends between the front and rear of the lamp base 7. Accordingly, the cooling current discharged out of the lamp unit 4 through the discharge port 43b strikes the side wall, which faces the discharge port 43b, and flows along the side wall 71. The front wall 72 prevents the cooling current that strikes the side wall 71 from flowing frontward.

The cooling current discharged out of the discharge port 43b is sent toward the rear by the discharge fan 92. In the present embodiment, the lamp base 7 includes the circulation holes 71a, which serve as the air mixing structure. The air drawn into the housing 10 flows through the circulation holes 71a. Accordingly, the cooling current discharged from the discharge port 43b is sent downward from a forward position. Further, air is drawn into the housing 10 through the air inlets 12a and then into the lamp base 7 through the circulation holes 71a. In this manner, the cooling current that cools the inner portion 2a of the lamp 2 mixes with the ambient air of the housing 10 of which temperature is lower than the cooling current.

As shown in FIG. 3, a gap is formed between the upper case 12 of the housing 10 and the lamp base 7 speaker 93, which is accommodated in the housing 10, is arranged in the gap so that the air drawn into the housing 10 easily flows to the circulation holes 71a.

The cooling current mixed with the ambient air of the housing 10 flows in the vicinity of the outer portion 2b of the lamp 2. Accordingly, the cooling current of which temperature has been decreased by the air mixing structure cools the outer portion 2b of the lamp 2 in the path of the cooling current that flows from the front toward the rear.

(1) The projector 1 includes the air mixing structure and the cooling current guide structure. The air mixing structure mixes the cooling current that cools the inner portion 2a of the lamp 2 with the air drawn into the housing 10 through the air inlets 12a. The cooling current guide structure guides the cooling current that has been mixed with the drawn-in air to the outer portion 2b of the lamp 2. Further, the cooling current that has cooled the inner portion 2a of the lamp 2 is guided to the outer portion 2b of the lamp 2 by the cooling guide structure. Thus, the inner portion 2a and outer portion 2b of the amp 2 are cooled without separating the flow of the cooling current that cools the inner portion 2a of the lamp from the flow of the cooling current that cools the outer portion 2b of the lamp 2.

The air mixing structure mixes the cooling current guided to the outer portion 2b of the lamp 2 with the air drawn into the housing 10 through the air inlets 12a. Thus, the air of which temperature is lower than the cooling current that has cooled the inner portion 2a of the lamp 2 (i.e., the ambient air drawn into the housing 10 under normal temperatures) is drawn into the housing 10 and mixed with the cooling current that has cooled the inner portion 2a of the lamp 2. This cools the cooling current that has been heated when cooling the inner portion of the lamp 2. Accordingly, in comparison with when the cooling current that has cooled the inner portion 2a of the lamp 2 is guided to the outer portion 2b of the lamp 2 without being mixed with the air that has been drawn into the housing 10, the outer portion 2b of the lamp 2 is effectively cooled. Since the outer portion 2b of the lamp 2 is effectively cooled, the fan 91 that moves the cooling current does not have to be enlarged, the weight and size of the fan 91 are reduced, and the space occupied by the fan 91 is decreased.

(2) The lamp base 7, which surrounds at least part of the lamp 2, is arranged in the housing 10. Further, the lamp base 7 includes the side wall 71 that extends between the front and rear of the lamp base 7. The side wall 71 functions as the cooling current guide structure. The cooling current that has cooled the inner portion 2a of the lamp 2 strikes the cooling current guide structure. Accordingly, the cooling current that has cooled the inner portion 2a of the lamp 2 strikes the side wall 71 of the lamp base 7. The cooling current then flows from the front toward the rear of the lamp base 7. Thus, the cooling current is guided rearward to the outer portion 2b of the lamp 2 from the portion of the side wall 71 that the cooling current has struck.

(3) The lamp base 7 includes the air mixing structure formed by the circulation holes 71a through which the air drawn into the housing 10 flows. Thus, the gas drawn into the housing 10 through the air inlets 12a flows through the circulation holes 71a and mixes with the cooling current in the lamp base 7. Accordingly, the cooling current that cools the inner portion of the lamp 2 is mixed with the air drawn into the housing 10 through the air inlets 12a even though the lamp 2 is encompassed by the lamp base 7.

(4) The lamp base 7 includes the circulation holes 71a. This easily shields the internal portion of the lamp base 7 while ensuring that a certain amount of air flows into the lamp base 7 through the circulation holes 71a. Further, each circulation hole 71a extends through the lamp base 7 and is elongated in a frontward direction. Thus, the air that flows from the front toward the rear easily enters the lamp base 7.

(5) The projector 1 includes the discharge fan 92, which discharges air out of the housing 10. The discharge fan 92 is arranged rearward from the outer portion 2b of the lamp 2 facing toward the rear of the lamp 2. The discharge fan 92 draws gas into the housing 10 through the air inlets 12a and sends the cooling current that has cooled the inner portion 2a of the lamp 2 toward the rear. Thus, with the single discharge fan 92, the cooling current that has cooled the inner portion 2a of the lamp 2 is sent toward the rear of the lamp 2 while being mixed with the air drawn into the housing 10 through the air inlets 12a, and the cooling current that has cooled the outer portion 2b of the lamp 2 is discharged out of the housing 10.

(6) The lamp 2 includes the connection terminal 24, which is connected to the lamp wires 53 that supply the lamp 2 with power, and the terminal support 23, which supports the connection terminal 24. The terminal support 23 is arranged on the reflector 22 and forms the outer portion 2b of the lamp 2. Thus, the cooling current cools the terminal support 23.

It should be apparent to those skilled in the art that the present invention may be embodied in many other specific forms without departing from the spirit or scope of the invention. Particularly, it should be understood that the present invention may be embodied in the follow in forms.

As long as the cooling current that cools the inner portion 2a of the lamp 2 is mixed with the air drawn into the housing 10 through the air inlets 12a, the air mixing structure is not limited to that of the above embodiment. For example, the location or shape of the lamp base 7 may be changed. Further, the side wall 71 of the lamp base 7 may be arranged in the vicinity of the air inlets 12a, and the speaker 93 may be eliminated. Additionally, the air drawn into the housing 10 through the air inlets 12a may be guided to the circulation holes 71a through a duct (not shown). Moreover, the shape of the circulation holes 71a may be changed.

As long as the cooling current that is mixed with the air drawn into the housing 10 is guided to the outer portion 2b of the lamp 2, the cooing current guide structure is not limited to that of the above embodiment. For example, the shape of the lamp base 7 may be changed.

The outer portion 2b of the lamp 2 may include parts other than the outer surface 22b of the reflector 22 and the terminal support 23. For example, the electrode container 21b of the arc tube 21 may be included in the outer portion 2b of the lamp 2. That is, the outer portion 2b of the lamp 2 does not include the inner surface 22a of the reflector 22.

The present invention is not limited to a three-chip LCD projector. For example, the present invention may be applied to a projector that includes a digital micromirror device (DMD), which serves as an electro-optic device.

The present examples and embodiments are to be considered as illustrative and not restrictive, and the invention is not to be limited to the details given herein, but may be modified within the scope and equivalence of the appended claims.

1. A video projector comprising:
a lamp including an arc tube, which generates light, and a reflector, which includes an inner surface that reflects light from the arc tube and an opposite outer surface, wherein the arc tube and the inner surface define an inner portion of the lamp, and at least the outer surface defines an outer portion of the lamp;
a housing that accommodates the lamp and includes an air inlet through which air is drawn into the housing from outside the housing;
an air mixing structure that mixes a cooling current that has cooled the inner portion of the lamp with the air drawn into the housing through the air inlet; and
a cooling current guide structure that guides the cooling current mixed with the air mixing structure to the outer portion of the lamp.

2. The video projector according to claim 1, wherein
the housing includes a lamp base that surrounds at least part of the lamp,
the lamp base includes a side wall that extends in a direction in which the light is emitted from the lamp, and
the side wall is arranged to function as the cooling current guide structure, and the cooling current that has cooled the inner portion of the lamp strikes the cooling current guide structure.

3. The video projector according to claim 2, wherein the lamp base is formed inside the housing and includes a circulation hole that functions as the air mixing structure through which the air drawn through the air inlet flows.

4. The video projector according to claim 3, wherein the lamp base includes a plurality of circulation holes,
each of the circulation holes extends from an outer side to an inner side of the lamp base along a direction in which the light is emitted from the lamp.

5. The video projector according to claim 1, further comprising a discharge fan that discharges air out of the housing, wherein the discharge fan is located in a rearward direction from the outer portion of the lamp, wherein the rearward direction is opposite to a direction in which light is emitted from the lamp, and the discharge fan draws air into the housing through the air inlet and draws the cooling current that has cooled the inner portion of the lamp to the discharge fan.

6. The video projector according to claim 1, wherein
the lamp further includes a connection terminal, which is connected to a wire that supplies the lamp with power, and a terminal support, which supports the connection terminal and is arranged in the reflector; and
the outer portion of the lamp includes the terminal support.

7. The video projector according to claim 1, further comprising a fan that produces a cooling current that cools the inner portion of the lamp, wherein the fan and the air inlet are arranged on opposite sides of the lamp.

8. The video projector according to claim 2, wherein the generated light is emitted from a front of the video projector, and the lamp base further includes a front wall, which is formed between the lamp and a front end of the side wall, and the front wall guides the cooling current that has cooled the inner portion of the lamp to the side wall.
